(19) United States
(12) Patent Application Publication
(10) Pub. No.: US 2012/0146894 A1
(43) Pub. Date: Jun. 14, 2012

(54) MIXED REALITY DISPLAY PLATFORM FOR PRESENTING AUGMENTED 3D STEREO IMAGE AND OPERATION METHOD THEREOF

(75) Inventors: Ung-Yeon YANG, Daejeon (KR); Gun A. LEE, Daejeon (KR); YONG WAN KIM, Daejeon (KR); Dong-Sik JO, Daejeon (KR); Ki-Hong KIM, Daejeon (KR)

(73) Assignee: Electronics and Telecommunications Research Institute, Daejeon (KR)

(21) Appl. No.: 13/315,815

(22) Filed: Dec. 9, 2011

(30) Foreign Application Priority Data
Dec. 9, 2010 (KR) 10-2010-0125837

(51) Int. Cl. G09G 5/00

(52) U.S. Cl. 345/156

(57) ABSTRACT

Various 3D image display devices divide and share a physical space for expressing a 3D image, and real-time contents information is generated based on user information and information on the divided space and displayed together using various 3D image display devices to present a 3D image naturally in a deeper, wider, and higher space. A mixed reality display platform includes an input/output controller controlling display devices including 3D display devices, an advance information manager establishing 3D expression space for each display device to divide or share a physical space by collecting spatial establishment of the display device, and a real-time information controller generating real-time contents information using user information and 3D contents for a virtual space. The input/output controller distributes the real-time contents information to each display device based on the 3D expression spatial information.

### CROSS-REFERENCE TO RELATED APPLICATIONS

This application claims priority under 35 U.S.C. §119 to Korean Patent Application No. 10-2010-0125837, filed on Dec. 9, 2010, in the Korean Intellectual Property Office, the disclosure of which is incorporated herein by reference in its entirety.

### TECHNICAL FIELD

The present invention relates to a mixed reality display platform for presenting an augmented 3D stereo image and an operation method thereof, and more particularly, to a mixed reality display platform for presenting an augmented 3D stereo image capable of presenting a natural 3D image in 3D space around a user using a plurality of 3D image display devices and an operation method thereof.

### BACKGROUND

Most 3D image presenting technologies, which have been popularized in movie and TV fields, use binocular disparity (a difference between images in which a 3D object of a human external environment is formed on retinas of both eyes) effects. However, this method presents an image having virtual depth perception in front and rear spaces of an image outputting surface to a user by outputting binocular disparity information to the image outputting surface which is spaced apart by a fixed distance, such as an LCD screen, which has a fundamental disadvantage of causing significant fatigue in a human visual movement structure.

In addition, an interactive hologram display technology which is a 3D image presenting technology presented in contents such as a movie is an ideal display technology that completely accepts a human stereo vision perception characteristic, but the implementation is a long way off in a current technological level, which leads general consumers' misunderstanding of a 3D image technology and disappointment to a current technology.

### SUMMARY

In the present invention, various homogeneous and heterogeneous 3D image display devices divide and share a physical space for expressing a 3D image and real-time contents information is generated based on user information and information on the divided space to display the generated real-time contents information together using various 3D image display devices.

An exemplary embodiment of the present invention provides a mixed reality display platform for presenting an augmented 3D stereo image, including: an input/output controller controlling a plurality of display devices including at least one 3D display device, which are associated with each other; an advance information manager establishing a 3D expression space for each display device to divide or share a physical space for expressing a 3D stereo image by collecting spatial establishment of the display device for each display device; and a real-time information controller generating real-time contents information using user information including information on binocular 6 degree-of-freedom, a gaze direction, and focusing information of a user and 3D contents for a virtual space, wherein the input/output controller distributes the real-time contents information to the display device on the basis of the 3D expression spatial information established for each display device and the user information.

Another exemplary embodiment of the present invention provides a mixed reality display platform for presenting an augmented 3D stereo image, including: an input/output controller controlling a plurality of display devices including at least one 3D display devices, which are associated with each other; an advance information manager including a space establishment collecting unit collecting information on an optimal 3D space which is expressible by the display device, a virtual space 3D contents database storing 3D contents for the virtual space, an authoring unit authoring information of a physical space collected by the space establishment collecting unit and information of the virtual space as an inter-placement relationship in a 3D space, and an optimal space establishment information database storing the authoring result as optimal 3D expression space establishment information for each display device; and a real-time information controller including a user information extracting unit extracting user information, a multi-user participation supporting unit managing an interrelationship of a plurality of users when the user is multiple, a real-time contents information generating unit generating real-time contents information on the basis of the user information, the interrelationship of the plurality of users, and the 3D contents for the virtual space, and a user adaptive device and image parameter controlling unit managing the user information and modifying optimal 3D expression space establishment information for each display device on the basis of personal information of the user which is collected in advance.

Yet another exemplary embodiment of the present invention provides an operation method of a mixed reality display platform for presenting an augmented 3D stereo image, including: collecting information on an optimal 3D space which is expressible from a plurality of display devices including at least one 3D display device; establishing a 3D expression space for each display device to divide or share a physical space for expressing a 3D stereo image for each display device on the basis of the collected information on the optimal 3D space; collecting user information including binocular 6 degree-of-freedom information, a gaze direction, and focusing information of a user; generating real-time contents information using 3D contents for a virtual space and the user information; and distributing the real-time contents information to each display device on the basis of the user information and the 3D expression spatial information established for each display device.

Other features and aspects will be apparent from the following detailed description, the drawings, and the claims.

### BRIEF DESCRIPTION OF THE DRAWINGS

FIG. 1 is a block diagram showing an overall configuration of a mixed reality display platform for presenting an augmented 3D stereo image according to an exemplary embodiment of the present invention.

FIG. 2 is a diagram showing a concept of 3D object perception by a binocular visual image.

FIGS. 3 and 4 are diagrams showing a binocular disparity and a position of an illusion for expressing a 3D image on a public screen and a wearable 3D display device, respectively.

FIGS. 5 and 6 are examples showing an error of a visualization range of a virtual image which can be expressed through a 3D display.

FIGS. 7A to 7C are diagrams showing dividing and sharing of a 3D image expression space in a mixed reality display platform for presenting an augmented 3D stereo image according to an exemplary embodiment of the present invention.

FIGS. 8A to 8C are diagrams showing an application example for multi-users of a mixed reality display platform for presenting an augmented 3D stereo image according to an exemplary embodiment of the present invention.

FIGS. 9A to 11D are diagrams showing various application examples of a mixed reality display platform for presenting an augmented 3D stereo image according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, a mixed reality display platform for presenting an augmented 3D stereo image and an operation method thereof according to exemplary embodiments of the present invention will be described in detail with reference to the accompanying drawings.

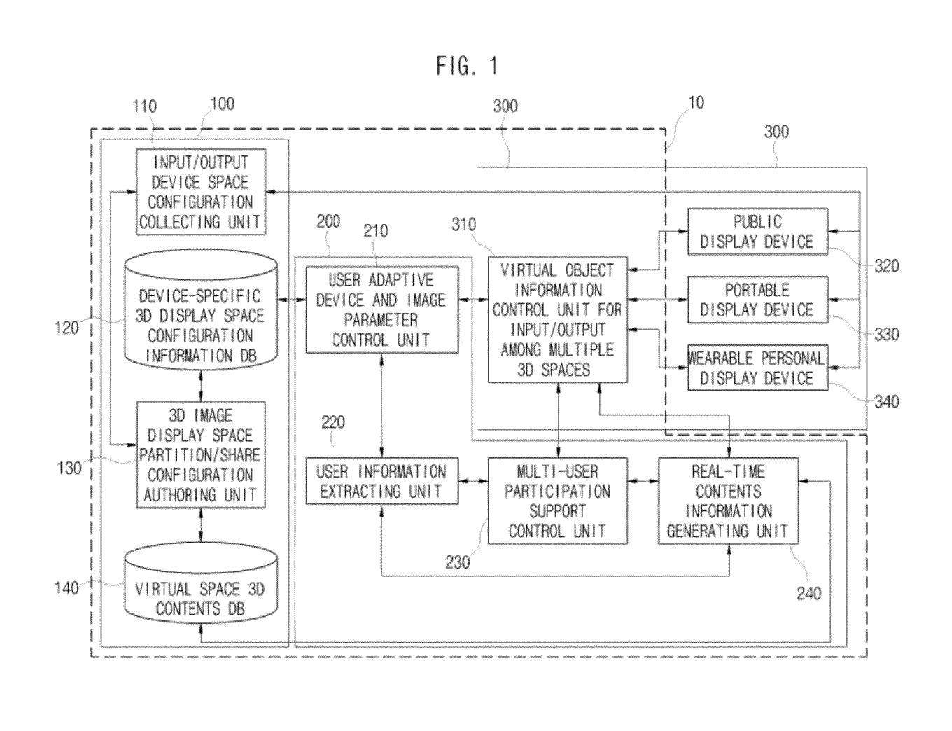

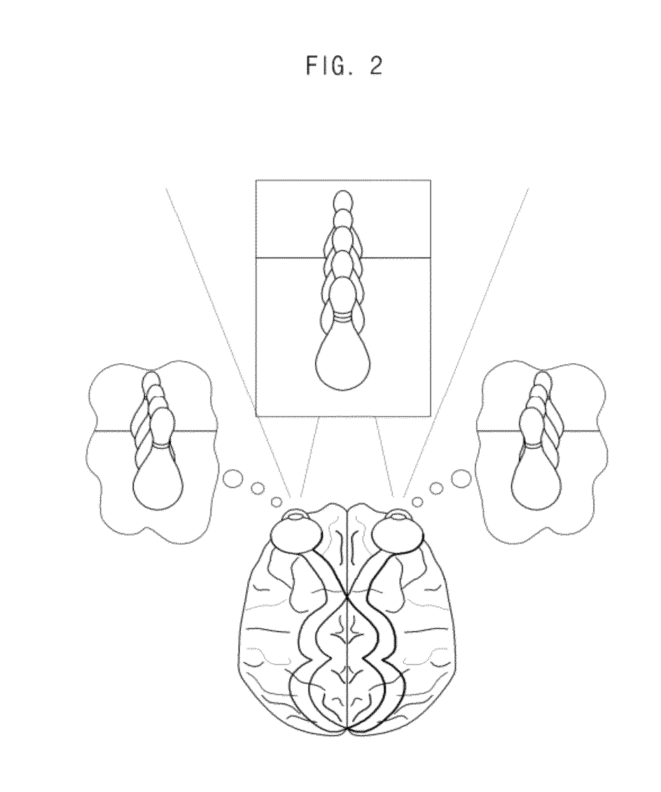

FIG. 1 is a block diagram showing an overall configuration of a mixed reality display platform for presenting an augmented 3D stereo image according to an exemplary embodiment of the present invention.

As shown in FIG. 1, the mixed reality display platform for presenting an augmented 3D stereo image according to the exemplary embodiment of the present invention is largely constituted by three groups of an advance information manager 100, a real-time information controller 200, and an input/output platform 300.

The advance information manager 100 establishes the relationship between hardware components and software components in advance and stores and manages the components in a database structure in order to configure one integrated virtual stereo space which is finally completed. To this end, the advance information manager 100 includes an input/output device space establishment collecting unit 110, a device optimal 3D expression space establishment information database 120, a 3D image expression space dividing/sharing establishment authoring unit 130, and a virtual space 3D contents database 140.

The virtual space 3D contents database 140 represents a database storing virtual reality and mixed reality software contents and includes model data for a 3D space, i.e., geographical features, natural features, environments, and objects which become interaction targets.

Using the data stored in the virtual space 3D contents database 140, in the mixed reality display platform for presenting the augmented 3D stereo image according to the exemplary embodiment of the present invention, a virtual reality space constituted by only virtual objects may be presented to a user or a mixed reality system in which a service scenario is performed through the interaction of digital contents objects of a virtual space, and real users and objects may be implemented.

The input/output device space establishment collecting unit 110 acquires information on an optimal 3D space which can be expressed by a predetermined display which may be included in the mixed reality display platform for presenting the augmented 3D stereo image from each of display devices 320, 330, and 340 according to the exemplary embodiment of the present invention. In this case, the display devices include a common display device, a portable (mobile) display device, and a personal wearable display device and a 3D space which can be expressed by each display device includes a volume of public screen (VPS), a volume of mobile screen (VMS), and a volume of personal virtual screen (VpVS).

The input/output device space establishment collecting unit 110 collects as information on a user's surrounding environment installation status information of input sensor devices (e.g., image input devices such as a camera, and the like, input devices based on positional and acceleration sensors, and the like) and information outputting devices (a sound effect outputting device, a mono display device, and the like) other than a 3D display device that are installed in a physical space. The installation status information of the input sensor devices and the information outputting devices may include 6 degree-of-freedom (e.g., 3 positions—x, y, and z and 3 poses—pitch, yaw, and roll) information and control related time information.

The input/output device space establishment collecting unit 110 provides the collected information to the 3D image expression space dividing/sharing establishment authoring unit 130.

The 3D image expression space dividing/sharing establishment authoring unit 130 as a 3D contents modeling tool provides a function to author physical spatial information provided by the input/output device space establishment collecting unit 110 and virtual spatial information stored in the virtual space 3D contents database 140 as an inter-arrangement relationship in a 3D space on the basis of a GUI. This is an operation for placing a zone which each 3D display device takes charge of in a 3D space model. The responsible zone may be manually adjusted by the user or automatically placed so that each display device appropriately shares and divides the 3D space at a predetermined numerical value by receiving minimum-appropriate-dangerous-maximum zone information (e.g., the depths of positive and negative parallaxes, and the like) from the corresponding 3D display device.

As described above, when a spatial relationship of appropriate virtual information which can be expressed by each display device is defined, initial establishment information for the defined spatial relationship is stored in the device optimal 3D expression space establishment information database 120.

The real-time information controller 200 extracts information on a single user or a plurality of users that participate every moment of operating the entire system to change a parameter set as an initial value in order to present a natural 3D space. The user information may include information on 6 degree-of-freedom (DOF) associated with a vision of each of the both eyes of a user, a view vector, and focusing information and may also include information on what types of input/output devices and sensors the user can interact at present. The real-time information controller 200 includes a user adaptive device and image parameter controlling unit 210, a user information extracting unit 220, a multi-user participation support controlling unit 230, and a real-time contents information generating unit 240.

The user information extracting unit 220 accurately tracks which space the user observes at present on the basis of 6 degree-of-freedom (position and pose) associated with the vision of each of the both eyes of the user, the view vector, and the focusing information to transfer related information to the user adaptive device and image parameter controlling unit 210 so that the display device capable of best expressing the 3D stereo effect of the corresponding space among the plurality of display devices processes information on the corresponding user.

Information on what types of input/output devices and sensors the user interacts with at present is collected to be transferred to the user adaptive device and the image parameter controlling unit 210, such that the system can process an operation of dividing and presenting various multimodal input/output information to individual users.

The multi-user participation support controlling unit 230 processes a situation in which the plurality of users use the mixed reality display platform for presenting the augmented 3D stereo image in one physical space. In this case, more than one of mixed reality display platforms for presenting the augmented 3D stereo image are present. Therefore, the multi-user participation support controlling unit 230 collects a current interaction state of the plurality of users (situational information on an action of observing the virtual space or interaction) to share virtual object information or distributive process information which each user can experience.

The user adaptive device and image parameter controlling unit 210 takes charge of adjusting a range of a partial value of information dividing and sharing processing condition value of each display device which is set as an initial value by the advance information manager 100, according to a user's personal physical and perceptive features and personal preference will. That is, since there may be a slight variation in a region to naturally feel a 3D effect by the personal physical and perceptive features, a transition boundary region of information is adjusted among 3D spaces (e.g., VPS, VpVS, VMS, and the like) by personalized advance information.

The real-time contents information generating unit 240 generates real-time contents information which is a final output result by processing an interaction event associated with the progression of service contents on the basis of information of the virtual space 3D contents database 140 and a user input acquired from the user information extracting unit 220 and the multi-user participation support controlling unit 230 and transfers the generated real-time contents information to the virtual object information input/output controlling unit 310 among multiple 3D stereo paces of the input/output platform 300.

The input/output platform group 300 includes various display devices 320, 330, and 340 and the controlling unit 310 for controlling the display devices.

The object information input/output controlling unit 310 among the multiple 3D stereo space separates the dividing and sharing information of the output result of the real-time contents information generating unit 240 on the basis of a multi-user condition and a personal optimized condition to transmit the separated information to each of the input/output devices 320, 330, and 340.

For convenience of description, in FIG. 1, the common display device 320, the portable display device 330, and the personal wearable display device 340 are shown one by one, but the three display devices do not need to be particularly provided and the mixed reality display platform for presenting the augmented 3D stereo image according to the exemplary embodiment of the present invention can be applied to a display system having two or more display devices including at least one 3D image display device. Further, of course, two or more display may be provided for each display device.

In FIG. 1, the object information input/output controlling unit 310 among the multiple 3D spaces directly controls each of the display devices 320, 330, and 340, but the object information input/output controlling unit 310 among the multiple 3D spaces and individual controlling units for controlling the display devices among the display devices 320, 330, and 340 may be provided. For example, examples of the individual controlling units may include a multiple common display device controlling unit controlling display devices such as a wall face type display device and a 3D TV, which is positioned in a surrounding environment, a multiple portable display device controlling unit controlling input/output devices which the user can carry and move, the multiple personal wearable display device controlling unit controlling an input/output device, which can be used with being closely attached to a human body such as a wearable computing device such as a head mounted display (HMD) or an eye-glasses (type) display (EGD).

In the mixed reality display platform for presenting the augmented 3D stereo image according to the exemplary embodiment of the present invention, the respective display devices 320, 330, and 340 receive user information, current interaction states of the multi-users, real-time contents information, and the like corresponding to the respective display devices 320, 330, and 340 from the object information input/output controlling unit 310 among the multiple 3D stereo spaces to present an appropriate 3D image using the same. In this case, each display device may include a display device including a visual interface device for presenting the mixture of multiple 3D images disclosed in Korean Patent Application Laid-Open No. 10-2006-0068508 or a face wearable display device for a mixed reality environment disclosed in Korean Patent Application Laid-Open No. 10-2008-0010502.

In the mixed reality display platform for presenting the augmented 3D stereo image according to the exemplary embodiment of the present invention, the units other than the display devices 320, 330, and 340 may be implemented through one apparatus 10 such as a computer and as necessary, the units may be implemented by two or more apparatuses or in a form in which some units are included in the display device. For example, when a predetermined common display device operates as a main display device, constituent members of the mixed reality display platform for presenting the augmented 3D stereo image may be implemented in the main display device.

FIGS. 2 to 4 are diagrams for describing a binocular disparity and the position of a virtual image for expressing a 3D stereo image.

In general, both left and right eyes sense 3D spatial information as an image with a visual disparity (d), which is independent and projected to retinas in a 2 dimension and a brain perceives a 3D stereo and a 3D object (see FIG. 2).

A 3D display technology using the above principle presents two left-right images onto one physical and optical screen and uses a technology (e.g., a polarizing filter) of separating the images to be independently transferred to the left and right eyes.

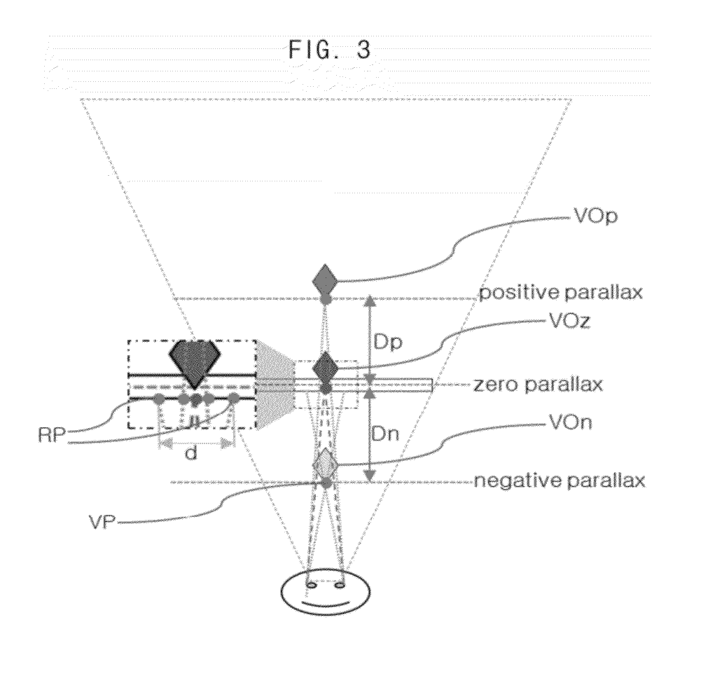

FIG. 3 is a figure showing situations of negative (a feeling in which an object is positioned in an area projected from a screen), zero (a feeling in which an object is positioned at the same distance as the screen), and positive (a feeling in which the object is positioned in a distant space behind the screen) by a visual disparity of an image outputted on a screen at the time of observing a general 3D TV or an external large screen in a 3D cinema.

Herein, VOp represents a virtual object in a positive parallax area, VOz represents a virtual object in a zero parallax area, VOn represents a virtual object in a negative parallax area, and Dp and Dn represent depths of positive parallax and negative parallax, respectively. RP represents a real point, VP represents a virtual point, and d represents a distance (zero parallax) on the screen.

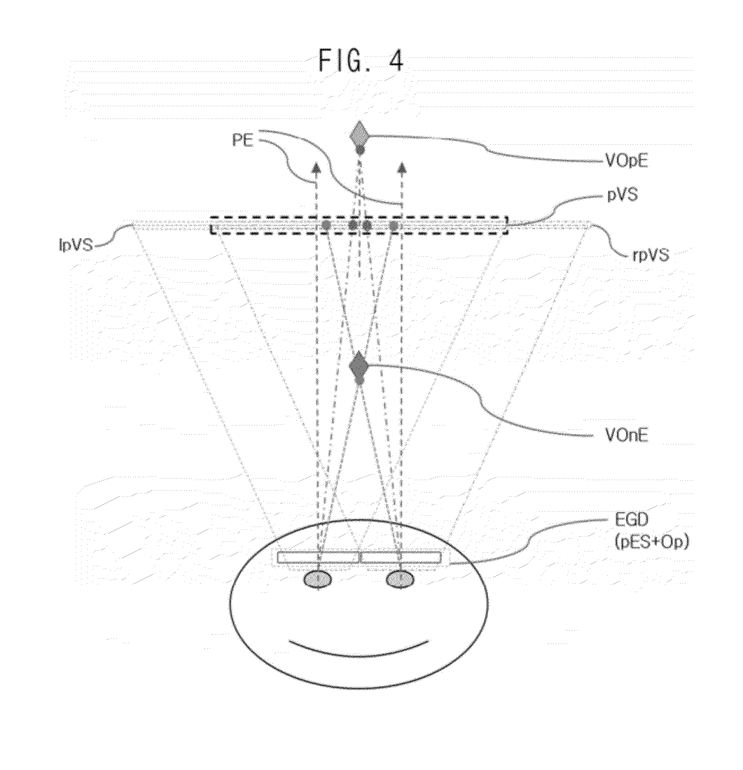

FIG. 4 is a figure for describing a principle in which a virtual screen (Pvs) is formed at a front side by a predetermined distance by an optical unit of a display device which is worn on a user's eye such as the EGD and a 3D image is expressed based thereon.

In FIG. 4, pES represents a personal eye screen, Op represents optics, lpVS represents a left eye's personal virtual screen, rpVS represents a right eye's personal virtual screen, pVS represents a personal virtual screen (overlap area), VOpE represents a virtual object of the positive parallax area of the EGD, VOzE represents a virtual object of the zero parallax area of the EGD, VOnE represents a virtual object of the negative parallax area of the EGD, PE represents a parallel eye vector, and VOE=VOpE+VOzE+VOnE.

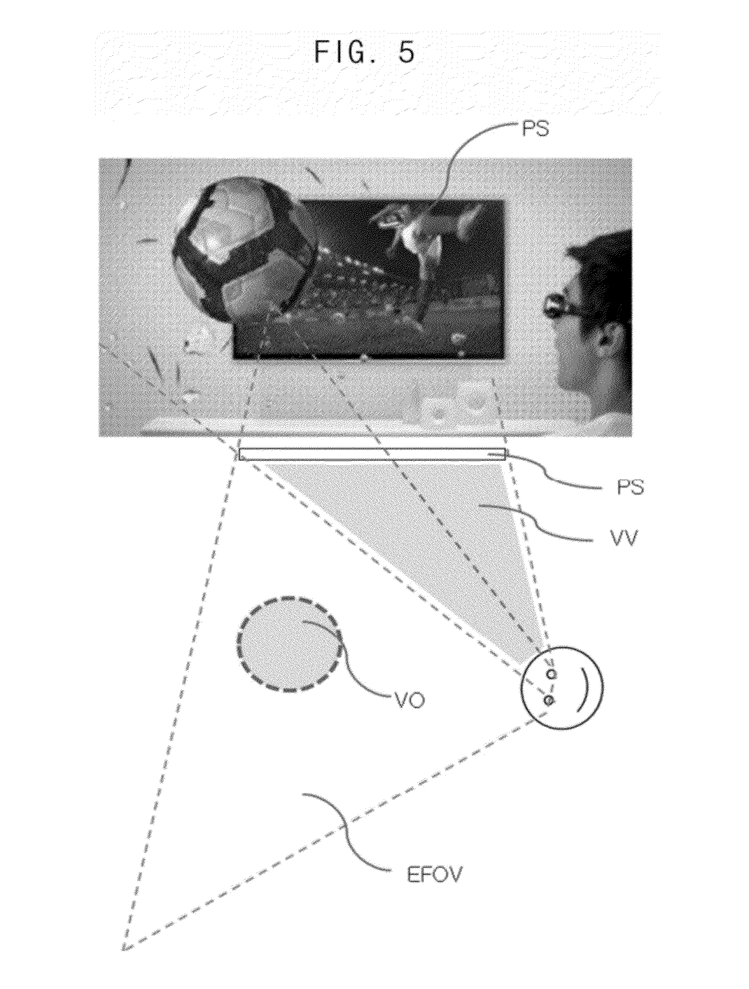

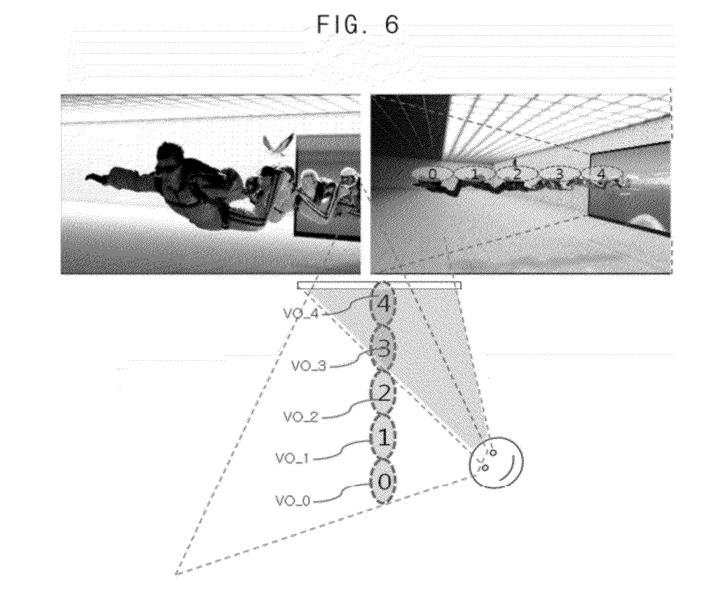

FIGS. 5 and 6 are diagrams showing examples of a visualization range of a virtual image expressible through a 3D display and an error thereof.

FIG. 5 is a diagram describing the 3D display and the visualization range of the expressible virtual image. A public screen (PS) part of FIG. 5 is one scene of 3D TV CF and shows a 3D effect in which a ball is projected from the screen in a shoot scene of a soccer game, but illustrates an abnormal situation which cannot be actually expressed by a negative parallax technique.

That is, assuming that visual fields of both left and right eyes of a general viewer are 90 degrees, a virtual object VO (e.g., the ball) is included within a visual field range (EFOV), but deviates from an image expressible space (VV) defined based on the viewer's gaze and a physical screen (PS), such that the virtual object is present in an area which is not actually viewed by the viewer.

That is, a situation in which a video image theoretically exits in a space where the video image can be expressed only by a hologram space display device is drawn.

FIG. 6 also shows a similar situation and when the viewer views a 3D TV screen in a diagonal direction as shown in the figure, only some virtual objects VO_3 and VO_4 positioned within the image expressible space defined based on the viewer's gaze and the physical screen may be perceived to be positioned in the space projected from the screen and virtual objects VO_2 to VO_0 positioned in the other spaces cannot be actually perceived by the viewer.

In all 3D image systems using a binocular vision type information display based on the existence of an image outputting surface (e.g., an LCD screen), a section of a comfortable depth feeling which the user feels is formed in a limited space on the basis of a physical and optical image surface. Therefore, an output to a deeper, wider, and higher space which virtual contents (e.g., a 3D image medium) intend to express has a limit by an existing technology. For example, a space which cannot be expressed physically and optically as a part that deviates from a field of view (FOV) defined from the viewer's viewpoint and an image expression surface is an area which the user cannot perceive or causes high visual fatigue to the user by setting an excessive image disparity.

Contrary to this, in the mixed reality display platform for presenting the augmented 3D stereo image according to the exemplary embodiment of the present invention, a limit in expressing a 3D spatial feeling can be overcome by dividing and sharing a virtual 3D expression space using multiple and plural 3D display devices.

Hereinafter, a method for expressing the 3D image implemented by the mixed reality display platform for presenting the augmented 3D stereo image according to the exemplary embodiment of the present invention will be described based on various application examples.

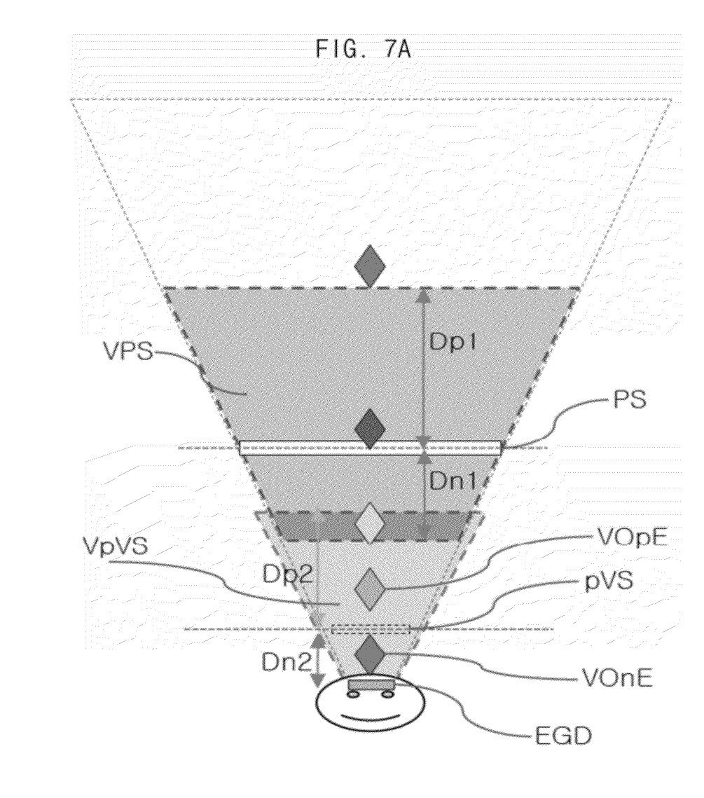

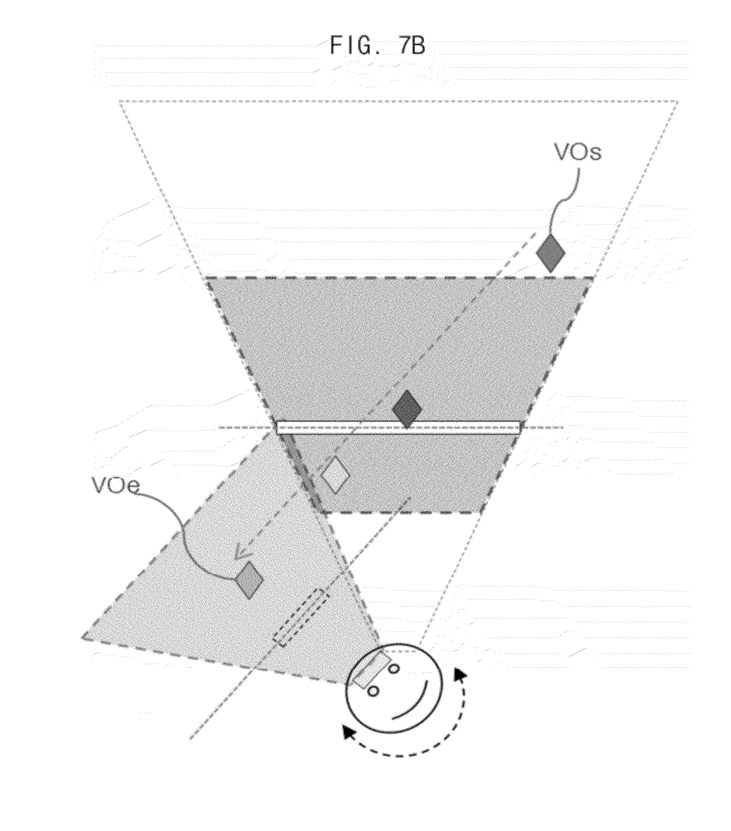

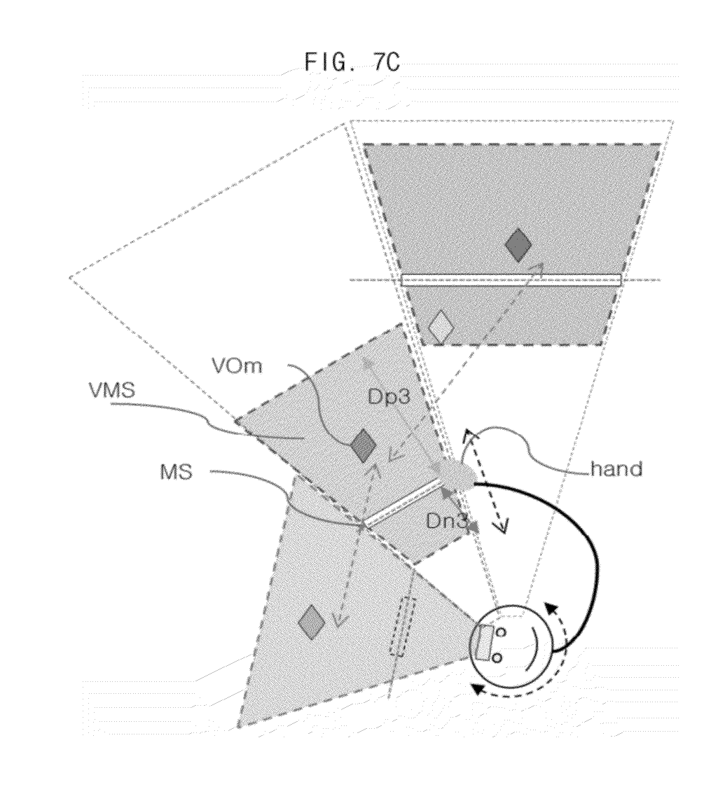

FIGS. 7A to 7C are diagrams showing dividing and sharing of a 3D image expression space in a mixed reality display platform for presenting an augmented 3D stereo image according to an exemplary embodiment of the present invention.

The exemplary embodiment of FIGS. 7A to 7C shows a relative using position of an image expression screen when both the wall face type 3D image display device and the wearable 3D EGD and/or the portable display device are used and the 3D space expression area of each the display device. In FIGS. 7A to 7C, PS presents a public screen, MS represents a mobile screen, VPS represents a natural 3D expression volume of PS, VpVS represents a natural 3D expression volume of pVS, VMS represents a natural 3D expression volume of MS, VOs represents a virtual object on start position, VOe represents a virtual object on end position, and VOm represents a virtual object on mobile screen.

As shown in FIG. 7A, a visual projection space (view frustum) may be defined on the basis of a boundary of one 3D image screen, and the position and direction of the viewer's gaze. In addition, a binocular disparity image outputted on one screen may define natural 3D image expressing spaces VPS, VpVS, and MVS defined by a boundary value enough for the viewer not to feel fatigue within a range of an excessive value.

In general, the 3D effect of the faraway feeling using the positive parallax is closer to a distance (e.g., an IPD-inter pupil distance) between visions of both left and right eyes of the viewer as the distance increases and a depth is perceived by another factor such as an overlap rather than a binocular disparity effect as the distance increases in the light of a human 3D space perception characteristic. However, when the negative parallax in which the object becomes close to the front of the viewer's eyes is used, an absolute value of the binocular disparity (d) increases to infinity, thereby causing the extreme visual fatigue feeling. Therefore, in one screen, as a natural 3D image expressing space, a limited space in which a distance value Dp of a positive area is larger than a distance value Dn of a negative area may be defined. Herein, since the expression of a faraway object becomes a completely parallel vision, the positive parallax area is theoretically infinite, but is limited to a predetermined area in consideration of the visual fatigue feeling.

According to the exemplary embodiment of the present invention, the limit in expressing the 3D spatial feeling described above can be overcome by displaying the 3D image through a plurality of virtual screens using a plurality of 3D display devices.

As shown in FIG. 7A, when the viewer gazes at a direction where the wall face type 3D display is positioned, a distance between the viewer and the screen (PS) is long (larger than Dn1), the 3D image may be presented to a space close to the viewer through the additional screen (pVS) using the EGD.

FIG. 7B shows a case in which the gaze of the viewer moves to the left side. Even when the viewer's viewpoint deviates from the 3D expression space of the wall face type 3D display, i.e., the area of the external screen (PS), 3D information may be presented using another expression space (VpVS) (3D expression space of the wearable 3D EGD) which moves according to the user's viewpoint.

FIG. 7C shows a case in which a mobile 3D display is additionally used. The viewer carries a device capable of displaying an additional screen (MS) to subdivide the 3D image expressing space and experience the 3D image information expressed in further natural and various spaces. In particular, when the mobile 3D display device is used as shown in FIG. 7C, a problem in a narrow field of view (FOV) of a general EGD device may be solved.

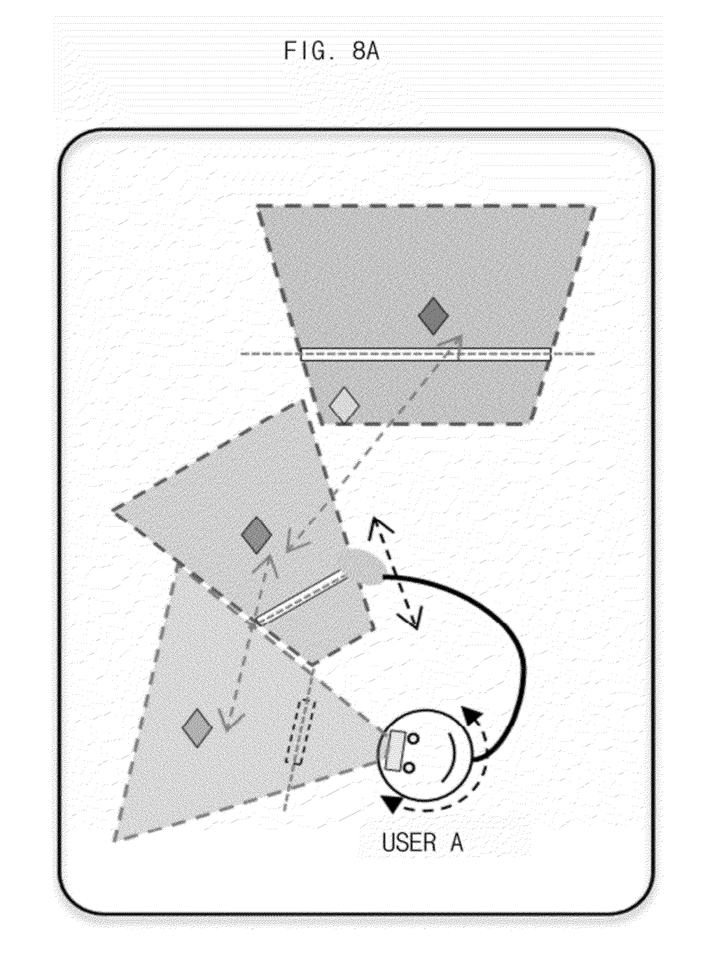

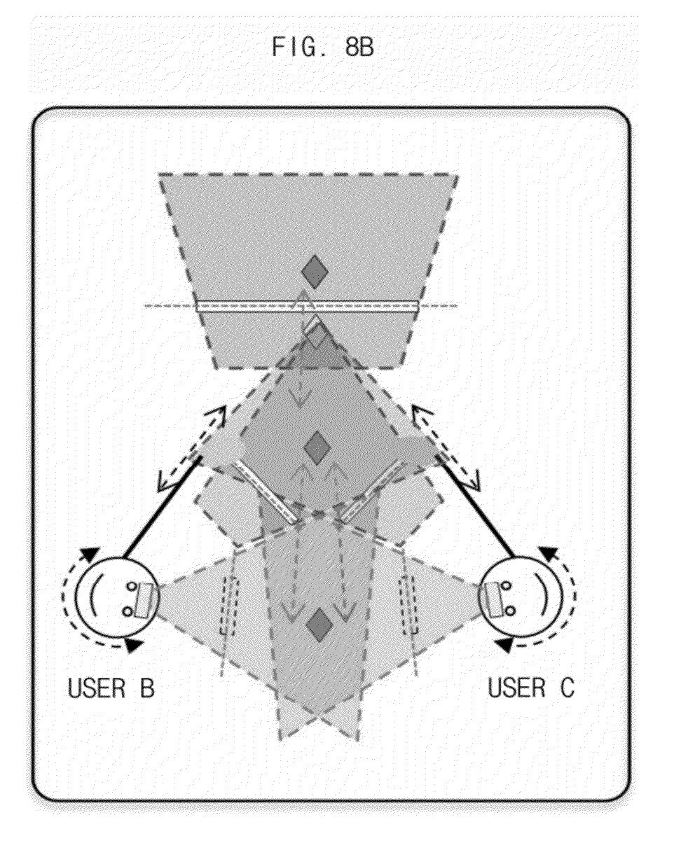

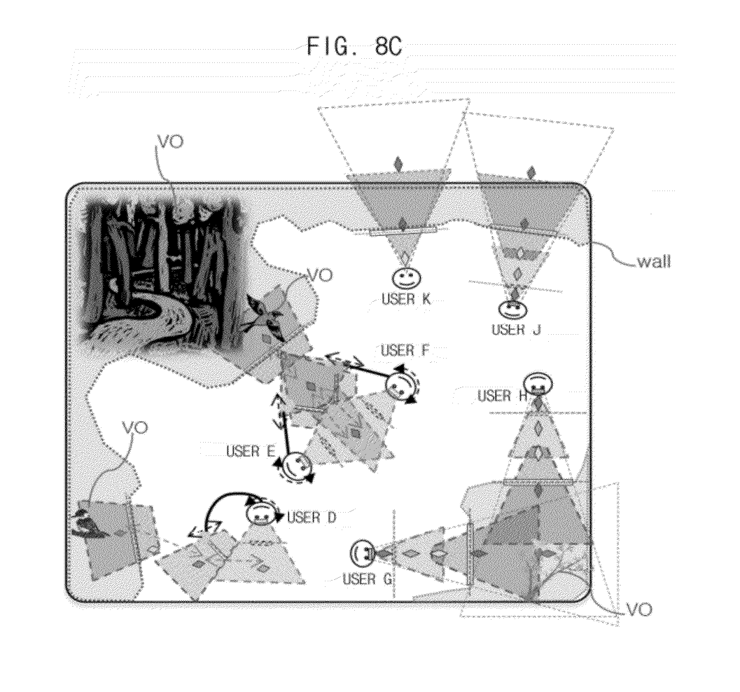

FIGS. 8A to 8C are diagrams showing an application example of displaying an augmented mixed reality 3D image to multi-users in a mixed reality display platform for presenting an augmented 3D stereo image according to an exemplary embodiment of the present invention.

FIG. 8A shows a situation in which a user A experiences 3D contents using devices (the EGD, the portable 3D display device, and the like) capable of naturally expressing a 3D spatial feeling along a movement path (projected out of the screen) of a virtual object.

FIG. 8B shows a situation in which each of different users (a user B and a user C) experiences an accurate 3D image for the same 3D image contents projected from a common display (PS) from his/her viewpoint. Each of the user B and the user C may experience the accurate 3D image for the same virtual object using his/her EGD, portable 3D display device, and the like.

FIG. 8C describes a case of a complex 3D image experience stage in which a plurality of users participate in the mixed reality display platform for presenting the augmented 3D stereo image according to the exemplary embodiment of the present invention. FIG. 8C shows a situation in which a plurality of users (users D to K) experience interaction for a virtual forest and virtual and real lives in an experience space having an interior of a virtual forest road through various input/output device platforms. As shown in FIG. 8C, the user may experience a mixed reality type service in which virtual and real spaces are fused through an exhibition space using virtual and real objects in a wall, a stereo image, and input/output interactive interfaces (e.g., sight, hearing, tactile, smell, and taste devices such as a user position tracking and gesture interface, a voice interface, and the like).

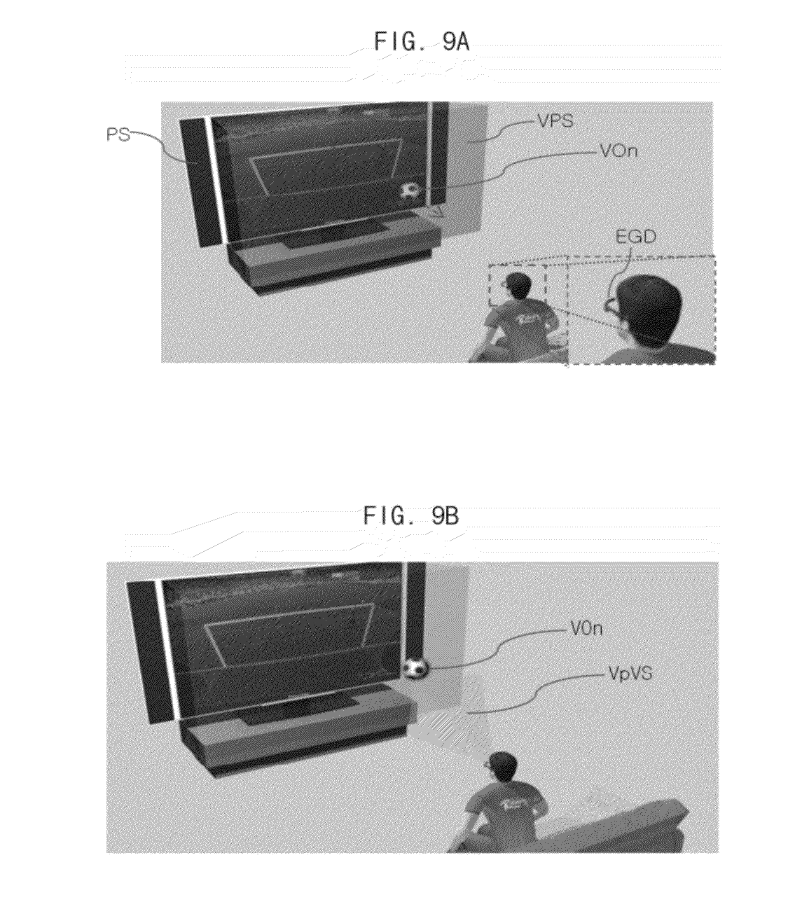

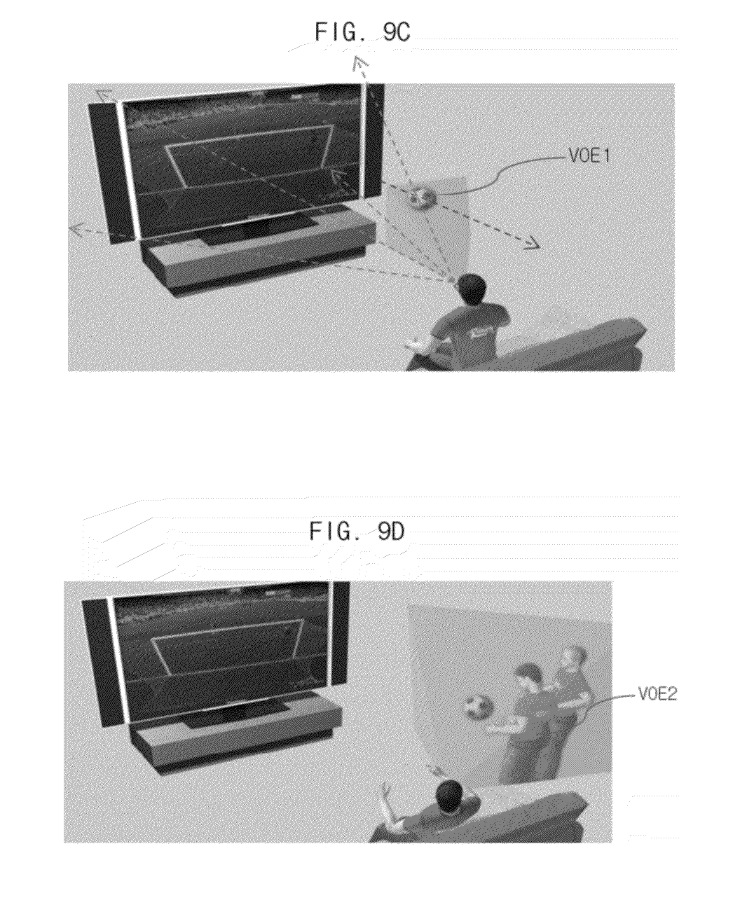

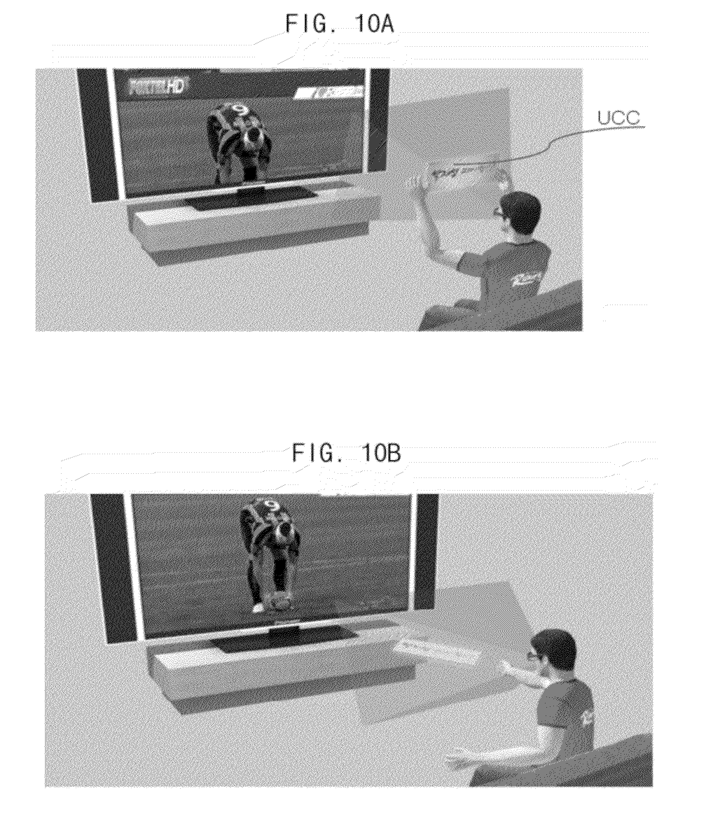

FIGS. 9A to 11D are diagrams showing various application examples of a mixed reality display platform for presenting an augmented 3D stereo image according to an exemplary embodiment of the present invention.

As shown in FIG. 9A, while the ball deviates from a goalpost and flies toward the viewer (outside the 3D TV), when the ball is expressed to be projected up to a maximum area which can be expressed as VOn in the VPS of the 3D TV to be close to a 3D expressing space transition (boundary) area, the VpVS of the EGD of the viewer is activated, as shown in FIG. 9B. Subsequently, as shown in FIG. 9C, in the VpVS that moves in link with the movement of the user's viewpoint, the movement of the ball (VOE1) is expressed (in this case, the VOE1 deviates from the VV area defined between the viewer and the 3D TV). As described above, a wide movement range of the virtual object (VOE1) may be expressed using two 3D display devices (the 3D TV and the EGD).

In FIG. 9D, a situation in which another virtual object VOE2 (e.g., a virtual cheering squad) expressed in the VpVS interacts with the VOE1 (the ball) (the flying ball is caught) is expressed. As described above, according to the exemplary embodiment of the present invention, a 3D image experience effect of an area which cannot be implemented in the related art can be easily acquired.

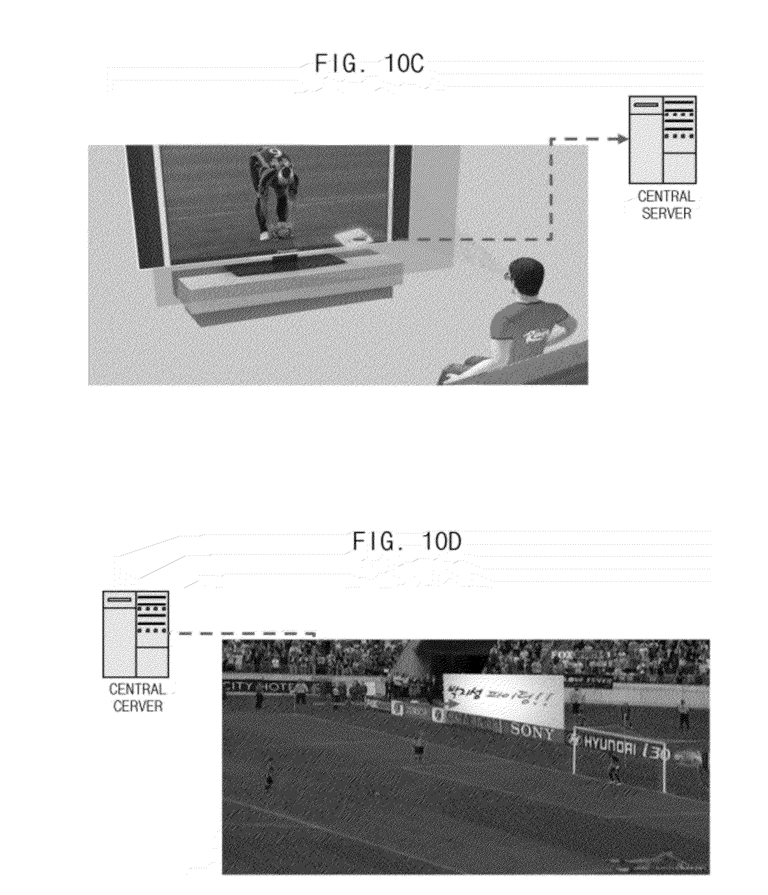

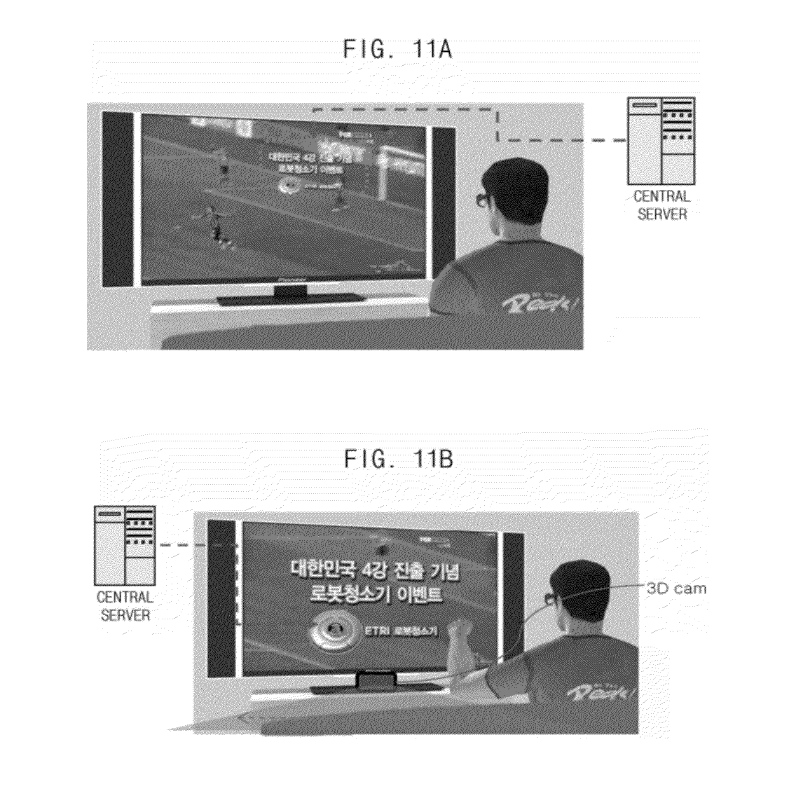

FIGS. 10A to 10D are diagrams showing another application example of using a mixed reality display platform for presenting an augmented 3D stereo image according to an exemplary embodiment of the present invention.

The application example presented in FIGS. 10A to 10D is a case of a service in which a 3D image display system according to the exemplary embodiment of the present invention is fused with an IPTV technology and a UCC technology. The viewer may implement a service of uploading contents of a 3D virtual space around the viewer which can be owned and controlled by the viewer to the inside of a TV program shared by the plurality of users and sharing the contents with the plurality of users.

As shown in FIG. 10A, digital contents (an UCC cheering advertisement) generated by the viewer are loaded to the VpVS area and thereafter, as shown in FIG. 10B, the viewer inputs a command to upload a UCC to the VPS expressed as the TV through gesture interaction. Then, as shown in FIG. 10C, UCC information received by the TV is uploaded to a central server and as shown in FIG. 10D, the central server controlling the exposure of the UCC (e.g., an advertisement) in a broadcast outputs a message uploaded by the viewer to an exposure controlling area (a virtual billboard).

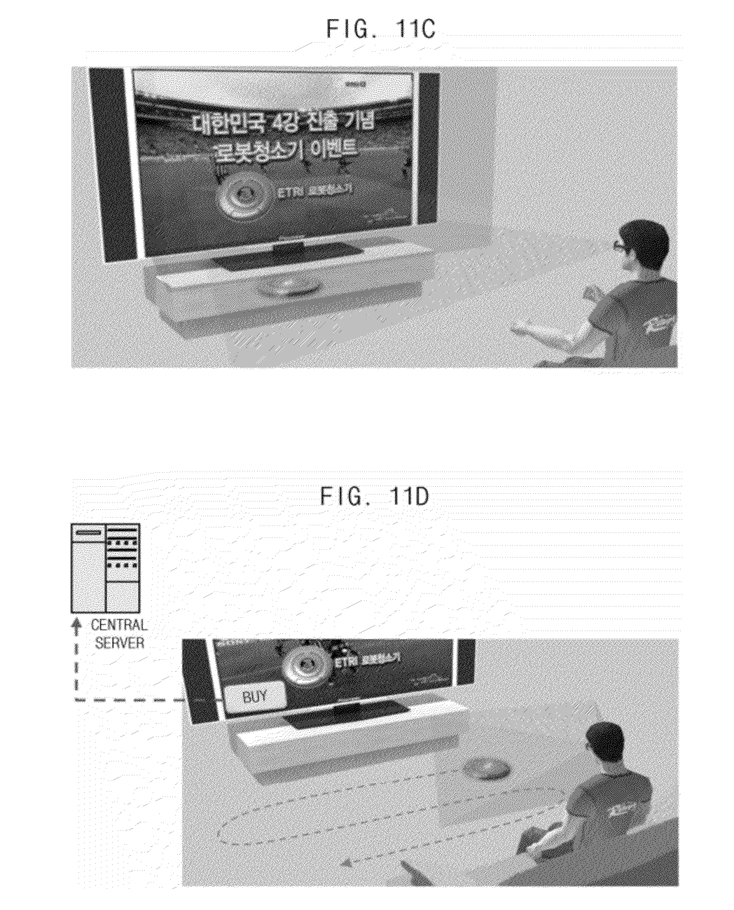

FIGS. 11A to 11D are diagrams showing another application example of a mixed reality display platform for presenting an augmented 3D stereo image according to an exemplary embodiment of the present invention.

The application example presented in FIGS. 11A to 11D is a case of a service in which the 3D image display system according to the exemplary embodiment of the present invention and a user-customized advertisement technology using the IPTV technology are fused with each other. That is, an interactive advertisement (e.g., when Korea wins the championship or a home appliance discount event advertisement is exposed) in which the viewer reacts the progress of the content of the TV program in real time is presented and a virtual used simulation situation is produced using an incorporated input/output sensor (e.g., a 3D information extracting sensor extracting 3D information in a user's living room) and a knowledge database in the mixed reality display platform for presenting the augmented 3D stereo image according to the exemplary embodiment of the present invention so that the viewer experiences whether a corresponding advertisement medium is suitable for a user's lifestyle, to allow the user to experience advertisement contents with a high realistic feeling.

That is, as shown in FIG. 11A, the central server exposes a predetermined advertisement by reacting with a predetermined event (e.g., the moment when a goal is scored in a soccer game) generated from the contents. Next, as shown in FIG. 11B, when there is no user's advertisement refusing action, the central server uploads additional information (a virtual simulation program of a robot cleaner) on a virtual object incorporated in advertisement contents to the TV and when the TV perceives that 3D information of a used space is required for interaction with a virtual object (a robot cleaner) included in the advertisement contents, 3D spatial structure information around the TV (in the living room) is scanned using a 3D spatial information collecting device (a 3D cam) incorporated in the TV.

As shown in FIG. 11C, when the user selects the experience of the contents of the advertisement contents (the robot cleaner), the virtual robot cleaner is outputted from the TV and moves to a living room space. In this case, when the virtual robot cleaner deviates from the VPS area of the TV, the virtual robot cleaner is visualized in the VpVS area of the viewer.

As shown in FIG. 11D, the virtual robot cleaner simulates virtual product operation production while performing a collision test on the basis of the collected 3D spatial information of the living room and the viewer virtually experiences a situation of actually purchasing the corresponding product and thereafter determines whether to purchase the product.

As an implementable scenario similar thereto, the user experiences virtual wearing and virtual placement of wearable clothes, accessories, and home interior products and may receive a help in deciding to purchase the advertised products.

According to exemplary embodiments of the present invention, a 3D image naturally expressed in a space with more depth, more width, and more height can be presented by overcoming a limit in expressing a limitative 3D spatial effect using one 3D display device. Since various 3D stereo contents services that overcomes a limitation of expression of the spatial effect can be provided using a 3D image technology, the services can be used in implementing virtual reality and mixed reality systems of various fields such as home appliances, education, training, medical, and military fields based on a 3D display platform.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A mixed reality display platform for presenting an augmented 3D stereo image, comprising:
an input/output controller controlling a plurality of display devices including at least one 3D display device, which are associated with each other;
an advance information manager establishing a 3D expression space for each display device to divide or share a physical space for expressing a 3D stereo image for each display device by collecting spatial establishment of the display device; and
a real-time information controller generating real-time contents information using user information including a user's gaze information and 3D contents for a virtual space,
wherein the input/output controller distributes the real-time contents information to each display device on the basis of the 3D expression spatial information established for each display device and the user information.

2. The mixed reality display platform for presenting an augmented 3D stereo image of claim 1, wherein when the user is multiple,
the real-time information controller generates the real-time contents information by further using the interrelationship of the plurality of users, and
the input/output controller distributes the real-time contents information to the display device on the basis of the 3D expression spatial information, the user information, and the interrelationship of the plurality of users.

3. The mixed reality display platform for presenting an augmented 3D stereo image of claim 1, further comprising:
an input sensor device installed in a physical space around the user and another information outputting device other than the display device,
wherein the advance information manager further collects installation status information of the input sensor device and the information outputting device.

4. The mixed reality display platform for presenting an augmented 3D stereo image of claim 1, wherein the advance information manager authors information on the established physical space and information on the virtual space in an interplacement relationship in a 3D space using the 3D expression spatial information and 3D contents for the virtual space and stores the authorizing result as optimal 3D expression space establishing information for each display device.

5. The mixed reality display platform for presenting an augmented 3D stereo image of claim 4, wherein the authoring is performed by the user or automatically performed from space establishment of the display device collected by the advance information manager.

6. The mixed reality display platform for presenting an augmented 3D stereo image of claim 1, wherein the real-time information controller modifies the 3D expression spatial information on the basis of personal information of the user which is collected in advance.

7. The mixed reality display platform for presenting an augmented 3D stereo image of claim 1, wherein the 3D expression spatial information for each display device is established to have an overlapped area with each other.

8. The mixed reality display platform for presenting an augmented 3D stereo image of claim 1, wherein the advance information manager includes:
a space establishment collecting unit collecting space establishment of the display device;
a virtual space 3D contents database storing 3D contents for the virtual space;
an authoring unit authoring information of the established physical space and the information of the virtual space as an interplacement relationship in a 3D space; and
an optimal space establishment information database storing the authoring result.

9. The mixed reality display platform for presenting an augmented 3D stereo image of claim 8, wherein the real-time information controller includes:
a user information extracting unit extracting the user information;
a multi-user participation supporting unit managing an interrelationship of a plurality of users when the user is multiple;
a real-time contents information generating unit generating the real-time contents information on the basis of 3D contents for the user information, the interrelationship of the plurality of users, and the virtual space; and
a user adaptive device and image parameter controlling unit managing the user information and modifying the optimal 3D expression space establishment information for each display device on the basis of the personal information of the user which is collected in advance.

10. The mixed reality display platform for presenting an augmented 3D stereo image of claim 9, wherein the input/output controller distributes the real-time contents information to the display device on the basis of the optimal 3D expression space establishment information for each display device modified by the user adaptive device and image parameter controlling unit, the user information, and the interrelationship of the plurality of users.

11. A mixed reality display platform for presenting an augmented 3D stereo image, comprising:
an input/output controller controlling a plurality of display devices including at least one 3D display devices, which are associated with each other;
an advance information manager including a space establishment collecting unit collecting information on an optimal 3D space which is expressible by the display device, a virtual space 3D contents database storing 3D contents for the virtual space, an authoring unit authoring information of a physical space collected by the space establishment collecting unit and information of the virtual space as an interplacement relationship in a 3D space, and an optimal space establishment information database storing the authoring result as optimal 3D expression space establishment information for each display device; and
a real-time information controller including a user information extracting unit extracting user information, a multi-user participation supporting unit managing an interrelationship of a plurality of users when the user is multiple, a real-time contents information generating unit generating real-time contents information on the basis of the user information, the interrelationship of the plurality of users, and the 3D contents for the virtual space, and a user adaptive device and image parameter controlling unit managing the user information and modifying optimal 3D expression space establishment information for each display device on the basis of personal information of the user which is collected in advance.

12. The mixed reality display platform for presenting an augmented 3D stereo image of claim 11, wherein the user information includes binocular 6 degree-of-freedom information, a gaze direction, and a focusing direction of the user, and information on an input/output device including the display device which interacts with the user.

13. The mixed reality display platform for presenting an augmented 3D stereo image of claim 11, wherein the input/output controller distributes the real-time contents information to the display device on the basis of the optimal 3D expression space establishment information for each display device modified by the user adaptive device and image parameter controlling unit, the user information, and the interrelationship of the plurality of users.

14. An operation method of a mixed reality display platform for presenting an augmented 3D stereo image, comprising:
collecting information on an optimal 3D space which is expressible from a plurality of display devices including at least one 3D display device;
establishing a 3D expression space for each display device to divide or share a physical space for expressing a 3D stereo image for each display device on the basis of the collected information on the optimal 3D space;
collecting user information including binocular 6 degree-of-freedom information, a gaze direction, and focusing information of a user;
generating real-time contents information using 3D contents for a virtual space and the user information; and
distributing the real-time contents information to each display device on the basis of the user information and the 3D expression spatial information established for each display device.

15. The method of claim 14, wherein:
the real-time contents information includes information for virtual 3D contents, and
further comprising displaying the virtual 3D contents in the virtual space for each display device after the distributing.

16. The method of claim 15, wherein:
the plurality of display devices include at least one portable 3D display device assigned for each of two or more of the users, and
the two or more users aquire 3D images through the portable 3D display device assigned for themselves.

17. The method of claim 15, wherein the plurality of display devices include two or more 3D display device including a portable 3D display device of the user, thereby the virtual object is diplayed through display regions of the two or more 3D display devices.

18. The method of claim 18, further comprising including contents of a 3D virtual space around the user, which is owned and controlled by the user, to the real-time contents information for the virtual space, thereby the contents of a 3D virtual space around the user is displayed to another user.

19. The method of claim 18, wherein the contents of a 3D virtual space around the user includes UCC (User Created Contents).

20. The method of claim 14, further comprising:
including interactive advertisement contents, which reacts to the real-time contents information in real time, to the real-time contents information for the virtual space, and
demonstrating virtual simulation using input and output sensors included in the mixed reality display platform for presenting an augmented 3D stereo image and knowledge database.
